(19) United States
(12) Patent Application Publication
(10) Pub. No.: US 2007/0045485 A1
(43) Pub. Date: Mar. 1, 2007

(54) Desk and chair set

(75) Inventors: Timothy J. Nichols, Muscatine, IA (US); Errol Pearsons, Grand Haven, MI (US); Thomas M. Edwards, Spring Lake, MI (US); LeRon Leist, Muscatine, IA (US); Dale Allen Johnson, Davenport, IA (US); Bradley Keith Bransen, Roseville, CA (US); Joseph Robert Russell, Albia, IA (US)

Correspondence Address: FAEGRE & BENSON, LLP;PATENT DOCKETING, 90 SOUTH SEVENTH STREET, 2200 WELLS FARGO CENTER, MINNEAPOLIS, MN, 55402, US

(73) Assignee: HNI Technologies Inc., Muscatine, IA (US)

(21) Appl. No.: 11/443,526

(22) Filed: May 30, 2006

Related U.S. Application Data
(60) Provisional application No. 60/685,641, filed on May 27, 2005.

(51) Int. Cl. B68G 5/00

(52) U.S. Cl. 248/118

(57) ABSTRACT

A desk assembly and method of manufacturing the desk assembly. The desk assembly includes a frame supporting a top assembly. The frame includes two or more leg portions telescopically coupled to one another such that the top assembly is height adjustable. The top assembly is formed from a plastic molded base bonded to a high pressure laminate sheet to form a seamless panel. The seamless panel is straightened from a deformed state during the manufacturing process to a flat surface by adhering the panel to a substrate with adhesive and pressure. The top assembly may include an angled portion set off by a flowing arc to increase user comfort. The desk assembly may include a chair assembly integrally formed with the frame and one or more semi-transparent modesty panels.

### CROSS REFERENCE TO RELATED APPLICATIONS

The present application claims the benefit of provisional U.S. Patent Application Ser. No. 60/685,641, entitled DESK AND CHAIR SET filed May 27, 2005, the entire disclosure of which is hereby incorporated herein by reference.

### TECHNICAL FIELD

The present invention relates to a desk and chair set and more particularly to a student desk and chair set with a seamless durable top surface.

### BACKGROUND

School desk and chair combinations are often not sufficiently durable. Many desk tops are made with high pressure laminate adhered to particle board where edges are covered with a “T-molding” or other edge bordering. These laminated desk tops often fail by separating, usually with the help of desk users who might pick at any visible seam between desk parts or layers.

### SUMMARY

In one embodiment, the present invention is a desk assembly including a desk frame having two or more leg portions and a top assembly supported by the desk frame. The top assembly is seamless and is formed of a plastic molded base bonded to a high pressure laminate sheet. A substrate is adhered to the plastic molded base and high pressure laminate sheet and may be one of molded wood, particle board or plywood. The top assembly may be height adjustable with the leg portions telescopically coupled to one another. The top assembly provides a seamless desk surface to reduce separation failures.

In another embodiment, the present invention is a desk assembly including a desk frame having two or more leg portions and a top assembly supported by the frame. The top assembly includes a top surface formed with a forward edge and an angled portion set off from the forward edge by a flowing arc. The angled portion slopes at an angle of from about 16° to about 20°. At a center of the forward edge of the top surface, the angled portion extends for about two inches from the forward edge to the flowing arc. The angled portion provides an eased portion for the user's comfort.

In another embodiment, the present invention is a method of forming a top assembly for a desk set. A high pressure laminate sheet is inserted into one side of an injection mold. The high pressure sheet is held in place by a series of vacuum ports. ABS plastic is molded around the high pressure laminate sheet to bond the high pressure laminate sheet to the ABS plastic. Because the two different materials have different shrink rates, the resulting panel is initially deformed. The seamless panel is then straightened and connected to a desk frame. The seamless panel is straightened by adhering the panel to a substrate with adhesive and pressure. The substrate may be one of molded wood, particle board or plywood.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is an isometric view of a desk and chair set.

FIG. 2 is an enlarged downward looking isometric view of the desk shown in FIG. 1.

FIG. 3 is an upward looking isometric view of the desk shown in FIG. 2.

FIG. 4 is an enlarged downward looking isometric view of the chair shown in FIG. 1.

FIG. 5 is an upward looking isometric view of the chair shown in FIG. 4.

FIG. 6 is a bottom plan view of the chair shown in FIGS. 4 and 5.

FIG. 7 is a downward looking isometric view of another embodiment of a desk and chair set.

FIG. 8 is an upward looking isometric view of the desk and chair set shown in FIG. 7.

FIG. 9 is an enlarged exploded isometric view of a portion of a top panel of a top assembly of the desk shown in FIGS. 1-3, 7 and 8.

FIG. 10 is an exploded view of the top assembly of the desk.

FIG. 11 is an isometric view of the top assembly of the desk.

FIG. 12 is a downward looking isometric view of a frame for the desk.

FIG. 13 is a side elevation view of the frame for the desk.

FIG. 14 is a rear elevation view of the frame for the desk.

FIG. 15 is a rear elevation view of the desk.

FIG. 16 is an enlarged sectional view taken along line 16-16 of FIG. 15.

FIG. 17 is a brief flow chart of a process for forming the top assembly of the desk.

FIG. 18 is a downward looking isometric view of a book box assembly for the desks of FIGS. 1-3, 7 and 8.

FIG. 19 is an isometric view of a modesty panel for the desks of FIGS. 1-3, 7 and 8.

FIG. 20 is an isometric view of the desk shown in FIGS. 1-3 with an attached book box assembly and modesty panel.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION OF THE INVENTION

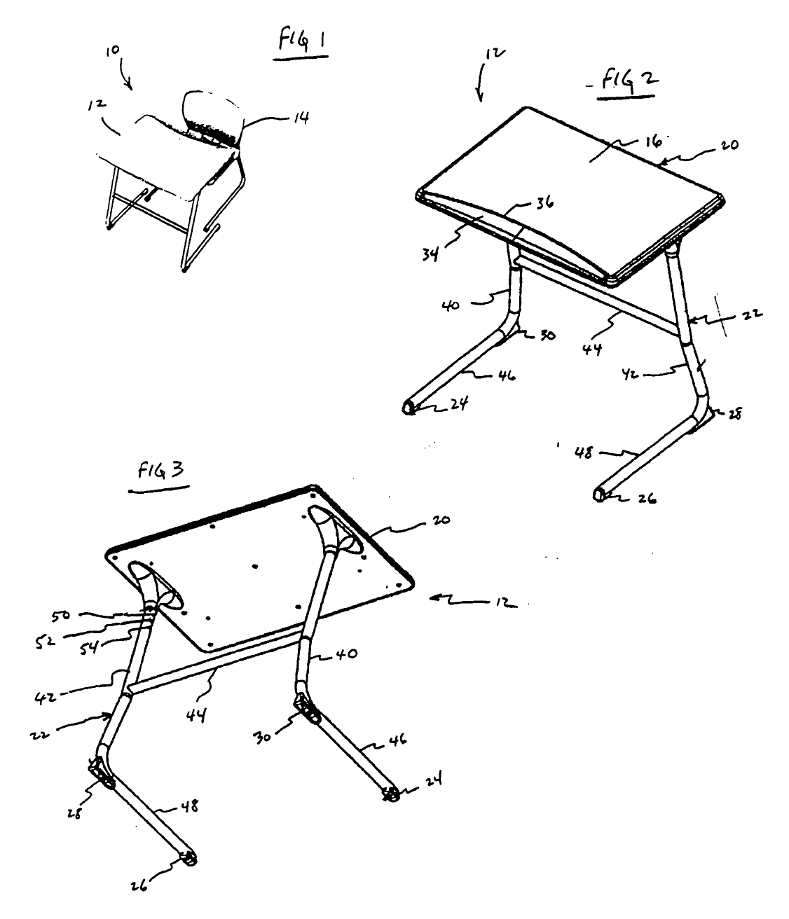

The present invention, in one embodiment, relates to a desk and chair set 10, shown in FIG. 1, of the type used by school children. The set includes a desk assembly 12 and a chair assembly 14. The desk and chair set is simply constructed, robust, durable, aesthetically pleasing and yet moderately priced. The writing or top surface 16 of the desk assembly is seamless so as to minimize separation failures common to student desks.

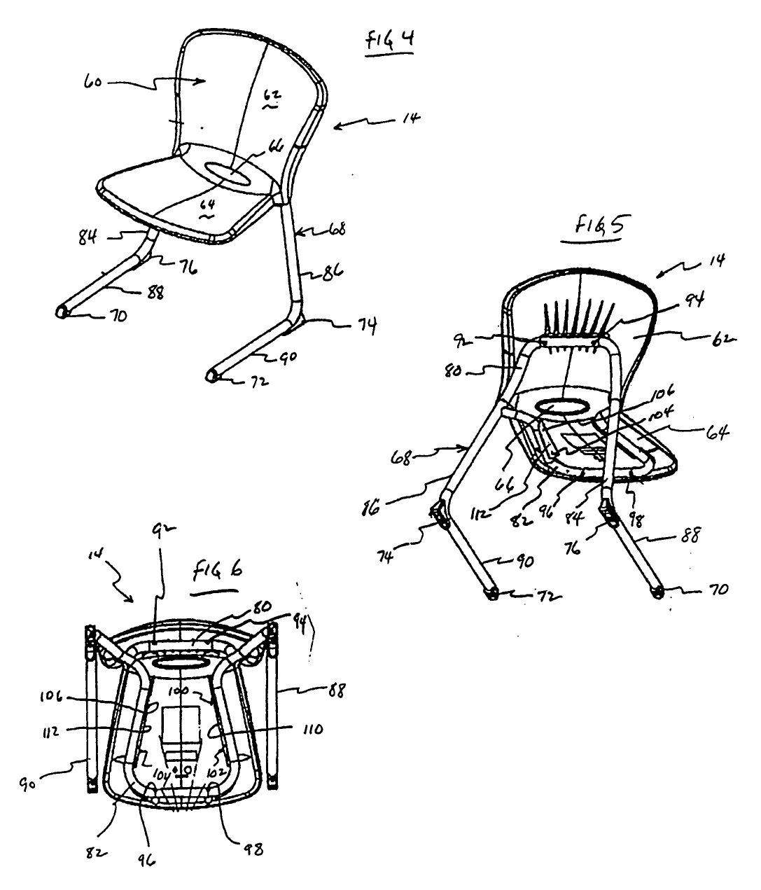

Referring now to FIGS. 2 and 3, the desk assembly 12 includes a top assembly 20, a frame 22 and four plastic glides 24, 26, 28, 30. The top assembly 20 includes the generally flat top surface 16 with an angled or eased edge portion 34 set off by a flowing arc 36 to enhance comfort for a desk user. The desk does not include sharp corners at the user interface so as to avoid increased pressure on the user's forearm area.

The desk frame 22 includes two leg portions 40, 42, a cross bar portion 44 and two runner portions 46, 48. The desk frame may be made of tubular steel or other suitable material and the cross bar portion 44 may be welded to the leg portions 40, 42.

The desk assembly 12 is height adjustable by virtue of openings 50, 52, 54 vertically aligned on the desk frame leg portion 42 and similar openings in the leg portion 40 (not shown) which enable the receipt of fasteners as will be explained below. The desk assembly may come in different sizes as either or both the frame and the top assembly may be scaled up or down as a function of the size of children expected to use the desk and chair set.

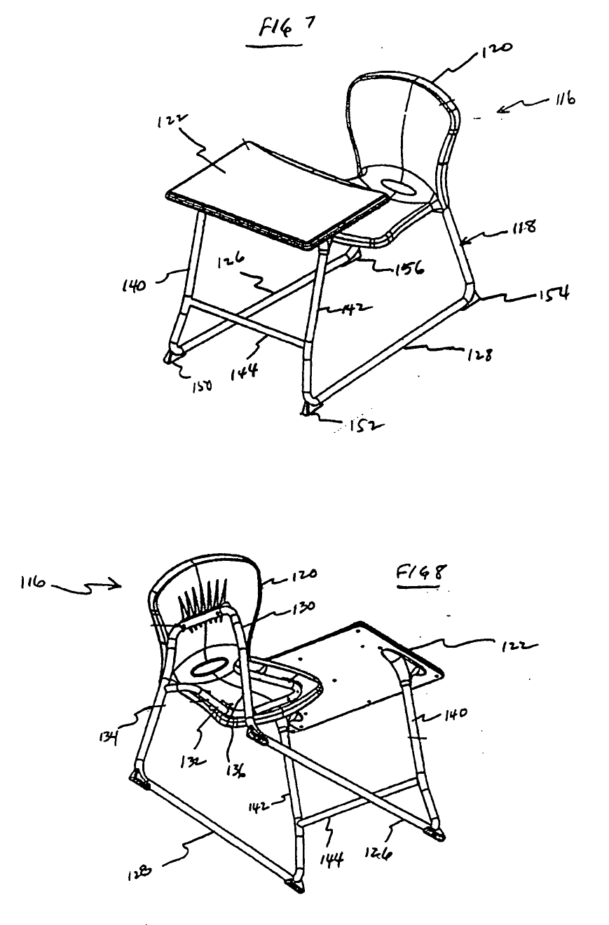

The chair assembly 14 shown in detail in FIGS. 4, 5 and 6 and may include a molded plastic shell 60 in which a back portion 62 and a seat portion 64 are integrally formed. An opening 66 may be provided between the back portion and the seat portion. The shell is mounted to a chair frame 68 and four plastic guides 70, 72, 74, 76 are attached to the chair frame.

The chair frame 68 may be formed of steel tubing of the same type and dimension as the desk tubing and may include an inverted U-shaped back portion 80, a generally U-shaped seat portion 82, two rear leg portions 84, 86 and two runner portions 88, 90 to which the glides 70, 72, 74, 76 are affixed. The shell 60 is attached to the frame in any convenient fashion, such as threaded fasteners 92, 94 attaching the back portion 80 of the chair frame to the back portion 62 of the shell 60. A second pair of threaded fasteners 96, 98 may attach the front of the seat portion 82 of the chair frame to the seat portion 64 of the shell 60 and a group of rivets 100, 102, 104, 106 may be used to connect a pair of integral shell flanges 110, 112 with the seat portion 82 of the chair frame 68. It is to be noted that the chair assembly may be scaled up or down as a function of the size of the expected user.

Another embodiment of a desk and chair set 116 is shown in FIGS. 7 and 8. The connected set includes an integral frame 118, a chair shell 120 that may be identical to the shell 60 of the chair assembly 14 illustrated in FIGS. 4-6 and a top assembly 122 that may be identical to the top assembly 20 illustrated in FIGS. 2 and 3. Connecting the chair shell 120 and the top assembly 122 is the frame 118 in which the desk and chair share common runner portions 126, 128 of the frame 118. The chair and desk runners are integral such that the distance between the chair shell 120 and the top assembly 122 is fixed. The remainder of the chair frame 118 including a back portion 130, a seat portion 132 and two rear leg portions 134, 136 may be identical to the chair frame 68 described in relation to FIGS. 4-6, and two leg portions 140, 142 and a cross bar portion 144 of the desk set 116 may be identical to the leg portions 40, 42 and the cross bar portion 44 described in relation to the desk frame 22 shown in FIGS. 2 and 3.

Plastic guides 150, 152, 154, 156 may be attached to the frame 118 at the lower corners as shown. The size of the desk and chair set 116 may be scaled up or down as a function of the size of the expected user.

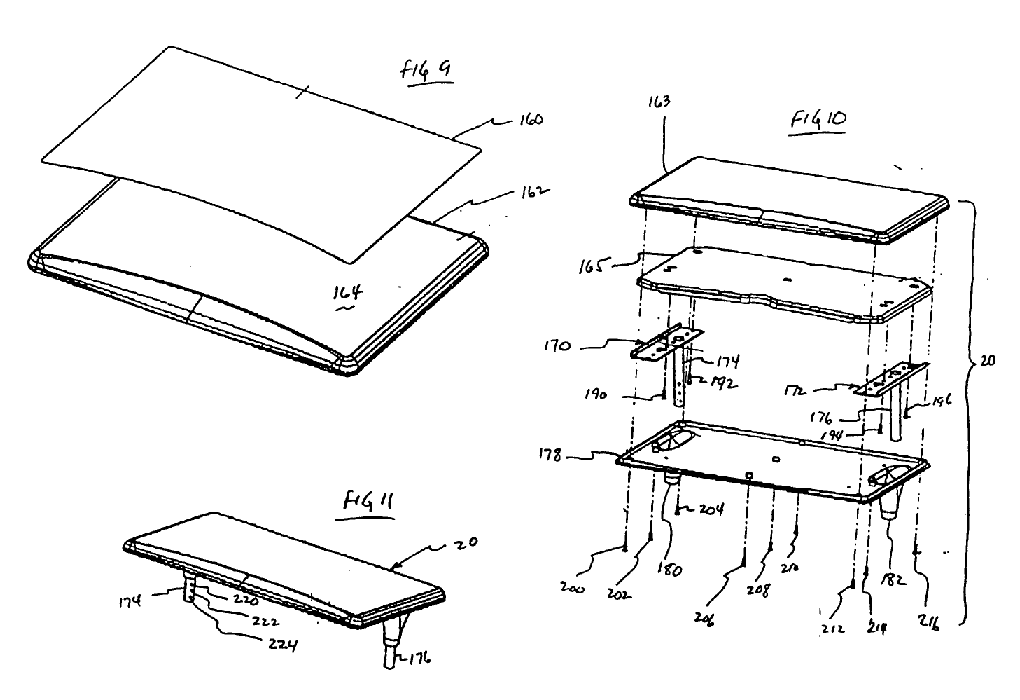

In FIG. 9 a portion of the desk top assembly 20 is illustrated and includes a high pressure laminate sheet (“HPL”) 160 and a plastic molded base 162 to form a durable, bonded panel 163. The panel is created in an injection molding machine well known to those skilled in the art. The high pressure laminate 160 is placed on one side of the injection mold and is held in place by a series of vacuum ports. Plastic is then injected and molded to the back of the HPL sheet thereby bonding the two materials together. The plastic may be ABS and assumes the shape of the base 162 in the mold. An indentation 164 is provided in the top surface of the base to accommodate the HPL sheet. Because two different materials with different shrink rates are used, the resulting bonded panel 163 is initially deformed when cooled.

The top assembly forming process continues by attaching the distorted bonded panel 163 of HPL and ABS to a substrate 165 using an adhesive and pressure or a combination of adhesive, pressure and mechanical fasteners. This step straightens the bonded panel 163 to a flat, durable writing surface which is seamless, robust, durable and aesthetically attractive. Furthermore, there is an absence of edges which may be picked at by school children to create a separation or delamination. The HPL sheet is surrounded by the ABS as shown in FIGS. 2 and 11. The adhesive may be hot melt adhesive or reactive hot melt, or any other suitable bonding system. The pressure may be about 2-3 psi. The substrate may be molded wood, particle board, plywood or any other suitable material.

The top assembly is completed by the addition of a pair of steel brackets 170, 172 which include leg supports 174, 176, and a bottom cover 178 which includes support sleeves 180, 182. The brackets may be attached to the substrate 165 with any suitable fasteners such as screws 190, 192, 194, 196 and the bottom cover 178 may be attached to the bonded HPL/ABS panel 163 using any suitable fasteners, such as screws 200, 202, 204, 206, 208, 210, 212, 214, 216 which sandwiches the brackets 170, 172 and the substrate 165 between the bottom cover 178 and the bonded panel 163. The bottom cover 178 may be formed of ABS.

As mentioned above, the desk top assembly 20 is height adjustable using the openings 50, 52, 54 in the desk frame as well as openings in the supports, such as the openings 220, 222, 224 in the support 174, whereby fasteners passing through the aligned openings of the desk frame and the supports fix the top assembly at a desired predetermined vertical elevation. Openings are also formed in the support 176 but are not visible in FIGS. 10 and 11.

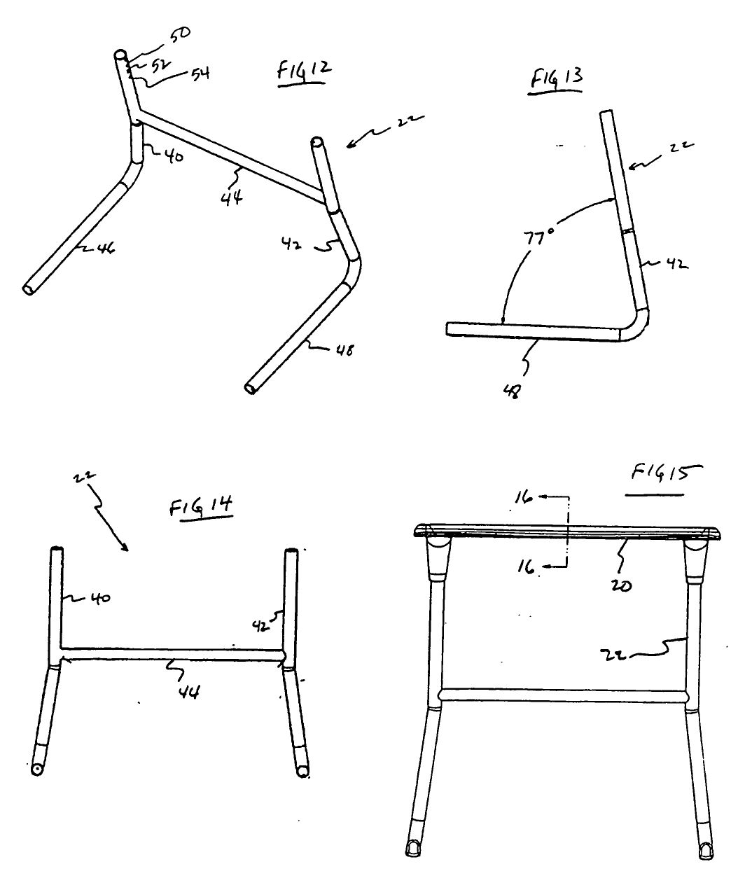

Referring now to FIGS. 12-14, the desk frame 22 is shown in more detail and includes the two leg portions 40, 42, the cross bar portion 44 and the runner portions 46, 48. At the upper ends of each of the leg portions, there are the series of openings, such as the openings 50, 52, 54, enabling the top assembly 20 to be vertically adjustable in relation to the desk frame 22.

In one version of the desk frame, the width of the leg portions is approximately 23 inches, the width of the runners is approximately 26 inches and the height of the desk frame is approximately 22 inches. The cross bar portion may be located approximately 10 inches from the top of the frame and the frame may have an angular disposition between the runner portions and the leg portions of about 77 degrees. As mentioned, it is to be understood that the desk frame may be built in smaller or larger versions as a function of the size of the people expected to be using the desk, and the desk frame as well as the chair frame may have a chrome or powder coat or any other suitable finish.

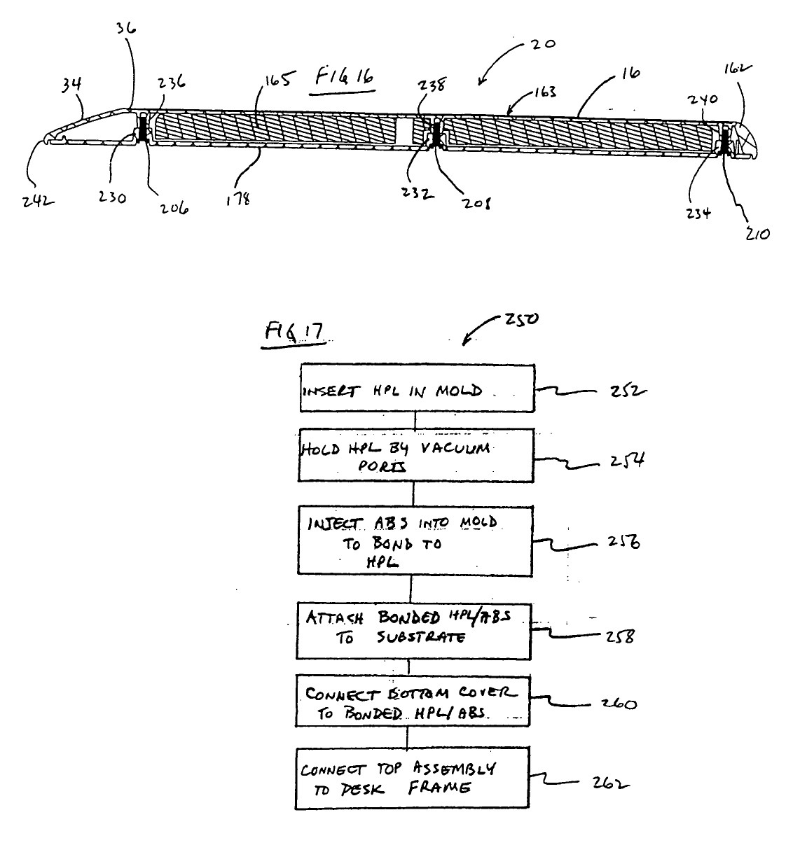

A complete desk may be seen in FIG. 15 including the desk frame 22 and the top assembly 20. The supports 174, 176 have a smaller diameter than do the leg portions 40, 42 of the desk frame so that the supports telescope downwardly into the leg portions. The interfaces between the upper supports and the lower leg portions are covered by the sleeves 180, 182 thereby giving the aesthetically appealing appearance of the desks shown in FIGS. 1-3, 7, 8 and 15. As mentioned above, both the supports and the leg portions of the desk frame include vertically disposed openings and by aligning the openings, fasteners, such as pins or screws, may be inserted to allow vertical adjustment of the top assembly 20 relative to the desk frame 22 and relative to a floor upon which the desk is disposed.

Referring now to FIG. 16, there is illustrated in more detail the top assembly 20 which includes the bonded panel 163, consisting of the HPL sheet to which the ABS plastic is molded around so as to create the molded-in, seamless top surface 16, the backing substrate 165, and the bottom cover 178. The cover 178 and the panel 163 include bosses 230, 232, 234, 236, 238, 240 to receive threaded fasteners, such as the screws 206, 208, 210, for forming a durable, seamless, strong and relatively inexpensive top assembly. These features make the top assembly especially well suited for school equipment applications.

The eased edge portion 34, FIGS. 2 and 16, slopes at an angle of about 16-20 degrees, and preferably about 18 degrees, and at the center of the desk the eased edge portion extends for about two inches from an edge 242 to the arc 36. This feature provides superior comfort to the desk/chair set user.

One embodiment of a process for forming the top assembly is briefly illustrated in a flow diagram 250, FIG. 17, and may include the steps of inserting 252 the high pressure laminate sheet into one side of an injection mold, holding 254 the high pressure laminate sheet by a series of vacuum ports, molding the ABS plastic around the HPL sheet to bond to the HPL sheet 160 to the ABS base 162, the molding step being designated 256, using an adhesive and pressure to attach the substrate 165 to the seamless panel 163, this step being designated 258, fastening 260 the bottom cover 178 to the panel 163 and connecting 262 the top assembly 20 to the desk frame 22.

In more detail the process of manufacturing and assembling of the desk is as follows. The HPL sheet having been routered to shape is placed in a holding fixture to ensure that the part is oriented in the proper direction. A linear positioning device picks the HPL sheet from a stack using suction cups and vacuum. The linear positioning device verifies that the sheet is in place through the use of vacuum signal switches. The sheet is positioned above a mold until a preceding cycle is completed. The mold opens to full stroke and the linear positioning device descends with the HPL sheet to a programmed centered position. The sheet is moved to the mold surface by the linear positioning device and light pressure is applied until vacuum (reduced pressure) in the mold, which is generated through vacuum pumps and applied through small port holes in the mold surface, holds the sheet in position. When the vacuum level reaches a minimum of about 21 inches Hg, the linear positioning device retracts. The linear positioning device then drops down approximately four inches and shifts to within one inch of the opposite mold face and begins generating vacuum in four suction cups on that side of the mold. When in position the press ejects a part forward until contact is made with the suction cups.

When a correct vacuum signal is received by the linear positioning device ejectors retract and the part is raised out of the mold where it is positioned until the mold closes and an injection unit fills the balance of the cavity with ABS plastic. Through heat and pressure the HPL sheet bonds in place with the ABS to form the top panel 163. When mold closes the linear positioning device transports the panel out of the press area to a position above a conveyor belt. The panel descends and rotates about 90 degrees and then is released to the conveyor belt where the panel is conveyed outside of a safety cage for finishing procedures. The linear positioning device moves back into position above the HPL sheet stack. The cycle repeats. The panel is placed in a fixture and clamped. Adhesive is applied to a bottom surface of the panel. A substrate is positioned onto the panel. A top clamp is closed and locked. The panel/substrate combination remains clamped until the adhesive is cured. The bonded panel and substrate is then removed from the clamping station. The supports and bottom cover are attached with threaded fasteners. The top assembly is connected to the desk frame. Beyond the specific steps mentioned above, standard molding techniques, equipment, temperatures and pressures as are known in the art are used in the process. It is also to be noted that variations of the process steps may be used without departing from the invention described herein.

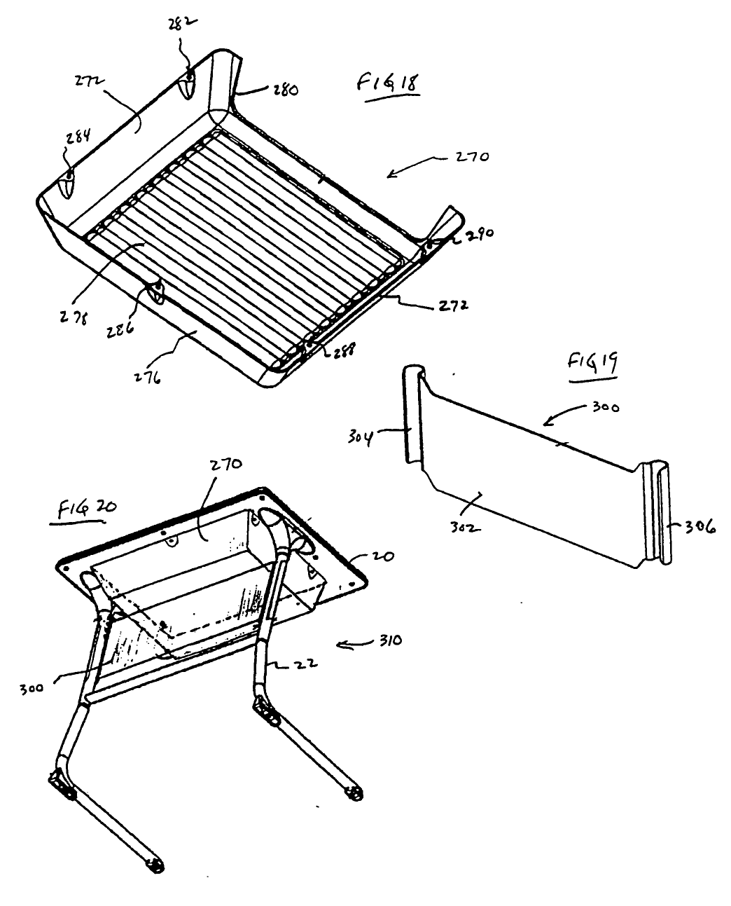

Referring now to FIG. 18, there is illustrated a book box assembly 270 having two side walls 272, 274, a back wall 276, a bottom wall 278 and an open front 280. Fasteners 282, 284, 286, 288, 290 may be used to connect the book box assembly to the lower cover 178 and the substrate 165 of the top assembly 20 to provide a student with a space for storing books, papers and school supplies. The book box assembly is made of semi-transparent molded thermoplastic such that light and objects are visible. For example, the material may be styrene methyl methacrylate copolymer sold under the brand ZYLAR 531 by the Nova Chemical Company of Calgary, Alberta, Canada. The plastic may have a nominal thickness of about 0.125 inches and includes a texture identified as MT 11030 (Mold Tech 11030). The product has a transmittance of about 89% and a haze of about 1.8%.

Referring to FIG. 19, there is illustrated a molded modesty panel 300 having a center portion 302 and two end sleeves 304, 306 which allow the panel to be snapped onto the leg portions 40, 42 of the desk frame 22. A desk 310 having attached the book box assembly 270 and the modesty panel 300 is illustrated in FIG. 20. The material of the modesty panel is frosted polycarbonate sold under the Plexiglass brand having a nominal thickness of about 0.125 inches. As with the book box assembly, the modesty is semi-transparent having approximately the same translucency characteristics as the book box assembly. The advantage of having semi-transparent modesty panels and book box assemblies is that student property may be monitored by school personnel.

Manufacture and assembly of the desk and chair sets are relatively easy and straightforward. Both frames for the desk and the chair are made of tubular steel which are cut and formed to the shapes shown in the drawing. The chair shell is molded as one piece and connected to the chair frame. The desk top assembly is formed as described above to provide a seamless bonded top panel and the top assembly is adjustably connected to the desk frame.

The material, dimensions and shapes described with respect to the embodiments generally shown in FIGS. 1-20 may be altered. For example, molded or machined wood, thermoplastics or other compositions may be used for the panel 163. The substrate 165 may be formed of wood, wood product board, thermoplastic composition or other suitable material. There are also many thermoplastics that may be textured of otherwise formed to be semi-transparent.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

I/We claim:

1. A desk assembly comprising:
a desk frame including two or more leg portions; and
a top assembly supported by the desk frame, the top assembly formed of a plastic molded base bonded to a high pressure laminate sheet.

2. The desk assembly of claim 1 wherein the top assembly further includes a substrate adhered to the plastic molded base and high pressure laminate sheet.

3. The desk assembly of claim 2 wherein the substrate is one of molded wood, particle board or plywood.

4. The desk assembly of claim 1 wherein the top assembly is seamless.

5. The desk assembly of claim 1 wherein the top assembly is height adjustable.

6. The desk assembly of claim 5 wherein each leg portion includes an upper portion telescopically coupled to a lower portion.

7. The desk assembly of claim 1 wherein a forward edge of the top surface includes an angled portion set off by a flowing arc.

8. The desk assembly of claim 1 further comprising a chair assembly coupled to the desk frame.

9. The desk assembly of claim 8 wherein the chair assembly includes a chair frame integrally formed with the desk frame.

10. The desk assembly of claim 1 further comprising one or more semi-transparent panels covering the desk frame.

11. A desk assembly comprising:
a desk frame including two or more leg portions; and
a top assembly supported by the desk frame, the top assembly including a top surface formed with a forward edge and an angled portion set off from the forward edge by a flowing arc.

12. The desk assembly of claim 11 wherein the angled portion slopes at an angle of from about 16° to about 20°.

13. The desk assembly of claim 11 wherein at a center of the forward edge of the top surface, the angled portion extends for about two inches from the forward edge to the flowing arc.

14. The desk assembly of claim 11 wherein the top surface of the top assembly is seamless.

15. The desk assembly of claim 11 wherein the top assembly is formed of a plastic molded base bonded to a high pressure laminate sheet.

16. A method of forming a top assembly for a desk set, the method comprising:
inserting a high pressure laminate sheet into one side of an injection mold;
holding the high pressure laminate sheet by a series of vacuum ports;
molding ABS plastic around the high pressure laminate sheet to bond the high pressure laminate sheet to the ABS plastic to form a deformed, seamless panel;
straightening the seamless panel; and
connecting the seamless panel to a desk frame.

17. The method of claim 16 wherein straightening the seamless panel further comprises adhering the seamless panel to a substrate using adhesive and pressure.

18. The method of claim 16 further comprising forming a forward edge of the seamless panel with an angled portion set off by a flowing arc.

19. The method of claim 18 further comprising forming the angled portion with a slope at an angle of from about 16° to about 20°.

20. The desk assembly of claim 18 wherein at a center of the forward edge of the seamless panel, the angled portion extends for about two inches from the forward edge to the flowing arc.
